(19) United States
(12) Patent Application Publication
(10) Pub. No.: US 2016/0215128 A1
(43) Pub. Date: Jul. 28, 2016

(54) POLYETHYLENE ARTICLES HAVING HIGH ABRASION RESISTANCE

(71) Applicant: CD POLYTECH, INC., Houston, TX (US)

(72) Inventor: STANLEY P. DUDEK, GALVESTON, TX (US)

(73) Assignee: CD POLYTECH, INC., Houston, TX (US)

(21) Appl. No.: 14/607,350

(22) Filed: Jan. 28, 2015

(51) Int. Cl. C08L 23/06; C08J 3/00

(52) U.S. Cl. CPC C08L 23/06; C08J 3/005; C08L 2205/025; C08L 2207/062; C08L 2207/068; C08L 2205/06; C08J 2323/06

(57) ABSTRACT

Very high molecular weight polyethylene compositions obtained from the blending of high density polyethylene and ultra high molecular weight polyethylene and a method for preparing the same are disclosed. The blending is effected by forming a first blend by incorporating ultra high molecular weight polyethylene into high density polyethylene material in an amount wherein the high density polyethylene remains as the matrix for the ultra high molecular weight polyethylene particles, forming a second blend by incorporating ultra high molecular weight polyethylene into high density polyethylene in an amount which is sufficiently large so that the ultra high molecular weight polyethylene becomes the matrix of the compound, and by blending the first and second blends. The compositions exhibit thermoplastic properties similar to those of high density so that they can be melt processed to obtain end use products that have improved abrasion resistance.

### TECHNICAL FIELD OF THE INVENTION

The present invention relates to polyethylene articles and, more particularly, to very high molecular weight polyethylene compositions obtained from the combination of high density polyethylene and ultra high molecular weight polyethylene and a method for the preparation thereof. Still more particularly, the present invention relates to very high molecular weight polyethylene compositions that have desirable thermoplastic properties and improved abrasion resistance.

### BACKGROUND OF THE INVENTION

Abrasion resistant compounds are well known. U.S. Pat. No. 3,956,253, issued May 11 1976, describes an olefin resin which uses peroxide crosslinking to produce an abrasion resistant compound.

U.S. Pat. No. 4,281,070 issued Jul. 28, 1981, describes a mixture of ultra high molecular weight polyethylene with and intermediate molecular weight polyethylene and a finely divided nucleating agent to make an abrasion resistant material that can be processed on conventional melt forming equipment such as extruders and injection molding machines. U.S. Pat. No. 4,487,875 issued Dec. 11, 1984 describes a composition of ultrahigh molecular weight polyethylene with a mixture of alcohols, hydrocarbon resins, and low molecular weight polyethylene to produced a processable compound.

U.S. Pat. No. 5,079,287 issued Jan. 7, 1992 to Takeshi, et al., describes an olefin resin composition for injection molding, which comprises (A) an olefin resin composition comprising ultra-high-molecular-weight polyethylene having an intrinsic viscosity of 10 to 40 dl/g as measured in decalin as the solvent at 135° C. and low-molecular-weight or high-molecular-weight polyethylene having an intrinsic viscosity lower than that of the ultra-high-molecular-weight polyethylene, in which the ultra-high-molecular-weight polyethylene is present in an amount of 15 to 40% by weight based on the sum of both of the polyethylenes and the two polyethylenes as a whole have an intrinsic viscosity [.eta.] c of 3.5 to 15 dl/g and a melt torque T lower than 4.5 kg.cm, and (B) 1 to 70% by weight, based on the olefin resin composition, of an additive selected from the group consisting of fine particulate inorganic fillers, fibrous fillers and liquid and solid lubricants.

U.S. Pat. No. 6,521,709 issued Feb. 18, 2003, to Pitteri, et al., discloses a polyolefin composition comprising from 10 to 95% by weight of a crystalline propylene polymer, A) having an MFR value equal to or lower than 60 g/10 min., and from 5 to 90% by weight of an ultra high molecular weight polyethylene, B) in form of particles having a mean particle size of from 300 to 10 .mu.m.

U.S. Pat. No. 6,790,923 issued Sep. 14, 2004, to Smith, et al., discloses melt-processible, thermoplastic polyethylene compositions of high resistance against wear and methods for making and processing same. Additionally, products comprising these compositions are described.

U.S. Pat. No. 6,809,154 describes HDPE compositions comprising a bimodal polymer and a nucleating agent, for producing molded articles with increased E-modulus and high ESCR, and the use of such compositions in the production of molded articles.

One disadvantage of the prior art is that in order to obtain high abrasion resistance, ultrahigh molecular weight polyethylene had to be used instead of the easily processed high density polyethylene. Because melt fracture is a major problem in the processing of ultrahigh molecular weight polyethylene, compression or ram extrusion processing equipment are used instead of standard plastic processing equipment such as single or twin screw extruders. The use of those equipment is uneconomical. According to the present invention, very high molecular weight polyethylene compositions are formed by blending high density polyethylene and ultra high molecular weight polyethylene. The compositions exhibit thermoplastic properties similar to those of high density polyethylene so that they can be melt processed to obtain end use products that have improved abrasion resistance.

These and other objects and advantages of the present invention will become apparent from the following description.

### SUMMARY OF THE INVENTION

Very high molecular weight polyethylene compositions obtained from the blending of high density polyethylene and ultra high molecular weight polyethylene and a method for preparing the same are disclosed. The compositions exhibit thermoplastic properties similar to those of high density polyethylene so that they can be melt processed to obtain end use products that have improved abrasion resistance.

A three step process is used to prepare the compositions. In the first step, ultra high molecular weight polyethylene is incorporated into high density polyethylene material in an amount wherein the high density polyethylene remains as the matrix for the ultra high molecular weight polyethylene particles. The amount of ultra high molecular weight polyethylene incorporated therein is sufficient to produce a resin with a high load melt index of less than 0.5 and preferably less than 0.3. The abrasion resistance of the material produced by the first step is significantly better than that of the high density polyethylene resin.

In the second step, ultra high molecular weight polyethylene is incorporated into high density polyethylene in an amount which is larger than that of high density polyethylene and which is sufficiently large so that the ultra high molecular weight polyethylene becomes the matrix of the compound. The proportional amounts of ultra high molecular weight polyethylene and high density polyethylene combined in this second step should be sufficient to produce a composition having, preferably, a high load melt index of less than 6. This compound has a better abrasion rating than high density polyethylene. Additives which are compatible with the compounds being combined may be added in order to minimize degradation during the first two steps described above.

In the third step of the process of the present invention, the composition produced by the first step is blended with the composition produced by the second step. The composition formed by this blending has a low high load melt index which is significantly and surprisingly lower than what would be expected from the average of the two blends and an improved abrasion resistance which is surprisingly higher than the average of the two blends would suggest.

The composition formed from the third step can be melt processed to create products having improved abrasion resistance.

### DETAILED DESCRIPTION OF THE INVENTION

According to the present invention, very high molecular weight polyethylene compositions (hereinafter referred to sometimes as “VHMWPE”) obtained from the combination of high density polyethylene (hereinafter referred to sometimes as “HDPE”) and ultra high molecular weight polyethylene (hereinafter referred to sometimes as “UHMWPE”) and a method for preparing the same are disclosed. The compositions exhibit thermoplastic properties similar to those of high density polyethylene so that they can be melt processed to obtain end use products that have improved abrasion resistance. The compositions have a high load melt index (hereinafter referred to as “HLMI”) @ 190° C. and 21.6 kg from 0.1 to 6 as measured by ASTM D1238.

The compositions can be used to make pellets that can be easily extruded by melt processing to form pipe, fittings, fiber and other molded or extruded articles that have superior abrasive resistance properties. For example, in mine applications where a pipe is employed in an environment where abrasive materials such as slurries are present, a pipe constructed from the compositions of the the present invention may be used for a significantly longer period of time before it must be replaced versus a typical HDPE bimodal pipe resin which erodes faster.

The compositions are prepared by a three step process. In the first step, UHMWPE is incorporated into a HDPE material in an amount wherein the UHMWPE particles are dispersed in the HDPE resin and the HDPE resin remains as the matrix for the UHMWPE particles. In that configuration, the UHMWPE is a filler in the HDPE material and is minimally degraded during the process of its incorporation in the HDPE material. The amount of UHMWPE incorporated therein is sufficient to produce a resin with a high load melt index (hereinafter referred to as “HLMI”) of less than 0.5 and preferably less than 0.3.

The abrasion resistance of the material produced by the first step is significantly better than that of the HDPE resin alone. More particularly, in a sand slurry abrasion test, if UHMWPE is assigned a rating of 100, the composition prepared in this first step gets a rating of between 130 and 160 and preferably between 130 and 150, depending on the HLMI of the composition. In the same test, a bimodal HDPE resin typically gets a sand slurry abrasion rating of about 225 to 300 and a typical HDPE resin gets a rating of about 400 to 600.

The abrasion resistance is related to HLMI and the molecular weight of the compound. More particularly, a lower HLMI corresponds to a lower amount of wear in the abrasion test. Similarly, in UHMWPE materials, a higher molecular weight corresponds to a higher wear resistance. For example, a resin having a molecular wight of 6 million has a better wear resistance than a resin having a molecular weight of 2 million. These correlation is is well documented in the product literature published by Ticona and Braskem who are two of the main producers of UHMWPE.

In the second step of the process for the preparation of the compositions of the present invention, UHMWPE is incorporated by extrusion into a HDPE resin in an amount which is larger than that of HDPE and which is sufficiently large so that the UHMWPE becomes the matrix of the compound and the HDPE is dispersed therein. This extrusion process produces a composition with a broad molecular weight distribution due to the degradation that occurs to the UHMWPE component. The proportional amounts of UHMWPE and HDPE combined in this second step should be sufficient to produce a composition having, preferably, an HLMI of less than 6. This compound can be easily extruded into a sheet or film and, depending on its HLMI, the extruded sheet or film has a sand slurry abrasion rating of 190 to 250 as compared to UHMWPE that has an abrasion rating of 100.

In order to minimize degradation during the first two steps described above, typical additives which are compatible with the compounds being combined such as, but not limited to, process aids, lubricants, and stabilizers, may be added.

In the third step of the process of the present invention, the composition produced by the first step is blended with the composition produced by the second step. The blending may be carried out through a simple physical blending such as with a ribbon blender or melt blending such as blending in an extruder. The composition formed by this blending has a low HLMI which is typically less than 1 HLMI, and an abrasion resistance similar to the compound formed in the first step but with the low melt fracture characteristics of the typical compound formed in the second step. The HLMI is significantly and surprisingly lower than what would be expected from the average of the two blends of HDPE and UHMWPE from which it was made. Further, the abrasion resistance is surprisingly higher than the average of the two blends would suggest.

The three step process described allows for the speedy mixing and fusion of the UHMWPE components into the other HDPE components in the composition by extrusion.

Because of its processing characteristics described, the VHMWPE composition formed from the third step can be processed through standard plastic processing equipment such as single or twin screw extruders and injection molding machines instead of compression or ram extrusion processing as is historically used for ultra high molecular weight polyethylene (UHMWPE). The molded parts produced from the VHMWPE pellets of the present invention exhibit excellent abrasion resistance.

The following examples further illustrate the invention, but are not to be construed as limitations on the scope of the invention contemplated herein.

### Abrasion Resistance Testing

The abrasion resistance is determined by sand slurry abrasion testing. Sand slurry abrasion testing is designed to accelerate the wear on a test sample so as to compare the rates of wear between different materials. A custom built device was used to perform the testing. The apparatus was a vessel that was 10 inches deep and six inches in internal diameter which is loaded with 2 kgs of 16 grit aluminum oxide and 2 kgs of water. This filled the bottom five inches of the vessel with an abrasive slurry. Each test used fresh grit and water. A test coupon was attached to the bottom of a shaft eight inches in length. That positioned the coupon in the slurry two inches above the bottom of the vessel and then the coupons were rotated at 1750 RPM for two hours.

Plaques with dimensions 10″×10″ (10 mm thick) were compression molded and then cut into 4″×1″ test coupons and tested for abrasion resistance in the test apparatus described above. In all cases the higher molecular weight materials (lower HLMI) outperformed the lower molecular weight materials (Higher HLMI). For example: a six million molecular weight UHMWPE (0 HLMI) sample lost 4% of its weight during the two hour test, a 0.5 HLMI material lost 5.7% of its weight during the two hour test, and a 6HLMI material loses 9% of its weight during the two hour test.

This apparatus and test procedure was designed to be more aggressive than the typical ASTM 4020-1a test procedure. The test time of two hours was specifically selected to maximize the amount of wear per unit of time. The longer the test runs the lower the wear rate per hour because of the erosion on the leading edge of the test sample. Wear rate was maximized by increasing the length of the sample and/or the thickness of the sample.

### Example 1

A blend of 8HLMI HDPE was blended 50/50 with 3 million molecular weight UHMWPE in a Dr. Collin 25 mm twin screw at the following processing parameters to produce uniform pellets.

Barrel Temperatures: 190° C., 240° C., 280° C., 280° C., 280° C.

Screw RPM's: 170 Feed Rate: 75% Melt Temp: 296° C.

The pellets were then tested in a Tinius Olsen Melt Rheometer at 190° C. and 21.6 kgs and exhibited a HLMI of 0.4 grams per 10 minutes.

A second blend of the same 8HLMI HDPE resin with the same 3 million molecular weight UHMWPE was mixed at a ratio of 35% 8 HLMI HDPE to 65% 3 million molecular weight UHMWPE. This blend was compounded as above but reached a melt temperature of 304° C. The pellets were then tested in a Tinius Olsen Melt Rheometer at 190° C. and 21.6 kgs and exhibited a HLMI of 2.1 grams per 10 minutes.

Plaques with dimensions of 10″×10″ (10mm thick) were then compression molded of both the above materials and then cut into 4″×1″ test coupons and tested for abrasion resistance in the test apparatus described above. The 0.4 HLMI material lost 5.7% of its' weight in the two hour sand slurry test while the 2.1 HLMI material lost 6.8% of its' weight. The 8 HLMI material used to produce the blends lost 9.1% of its' weight when tested alone and the 3 million molecular weight UHMWPE used to produce the blends lost 4.2% of its' weight when tested alone.

### Example 2

A 50/50 mix of the pellets from the first blend in Example 1 with those of the second blend in Example 1. They then were then compounded into pellets on a Dr. Collin 20 mm single screw extruder at the following conditions to make uniform pellets of the blend.
Barrel Temperatures: 180° , 240° , 260° C., 260° C.
Screw RPM : 50 Melt Temperature: 263°

The pellets were then tested for melt flow as above and the result was 0.7HLMI. This is significantly and surprisingly lower than what would be expected from the average of the two blends from which it was made. Plaques were then molded as described above of this blend and abrasion tested, as described above. The resulting weight loss of only 5.9% was also surprisingly lower than the average of the blend would suggest.

While the invention is described with respect to specific embodiments, modifications thereof can be made by one skilled in the art without departing from the spirit of the invention. The details of said embodiments are not to be construed as limitations except to the extent indicated in the following claims.

1. A composition, comprising:
a high density polyethylene; and
an ultra high molecular weight polyethylene,
wherein the composition has a high load melt index in the range of about 0.1 to 6 as measured By ASTM D1238 at 190° C. and 21.6 kg.

2. A composition according to claim 1 wherein the composition has a high load melt index in the range of about 0.1 to 1 as measured By ASTM D1238 at 190° C. and 21.6 kg.

3. A composition, comprising:
a high density polyethylene; and
an ultra high molecular weight polyethylene,
wherein the composition has a high load melt index that is lower than the high load melt index of a direct blending of the high density polyethylene and the ultra high molecular weight polyethylene.

4. A process of preparing a composition having low high load melt index, comprising:
first mixing a first ultra high molecular weight polyethylene and a first high density polyethylene in sufficient amounts to form a first matrix compound wherein the first ultra high molecular weight polyethylene is dispersed in the first high density polyethylene; and
second mixing a second ultra high molecular weight polyethylene and a second high density polyethylene in sufficient amounts to form a second matrix compound wherein the second high density polyethylene is dispersed in the second ultra high molecular weight polyethylene; and
third mixing the first matrix compound and the second matrix compound.

5. (canceled)

6. (canceled)
